(19) United States
(12) Patent Application Publication
(10) Pub. No.: US 2022/0036339 A1
(43) Pub. Date: Feb. 3, 2022

(54) PAYMENT VERIFICATION METHOD AND SYSTEM

(71) Applicant: Alipay (Hangzhou) Information Technology Co., Ltd., Hangzhou (CN)

(72) Inventors: Jiongguang Guo, Hangzhou (CN); Tingwen Li, Hangzhou (CN); Lingnan Shen, Hangzhou (CN); Tangqi Chen, Hangzhou (CN); Kaihua Lu, Hangzhou (CN); Ming Lu, Hangzhou (CN)

(73) Assignee: Alipay (Hangzhou) Information Technology Co., Ltd.

(21) Appl. No.: 17/354,255

(22) Filed: Jun. 22, 2021

(30) Foreign Application Priority Data
Aug. 3, 2020 (CN) 202010767469.3

(51) Int. Cl. G06Q 20/32; G06Q 20/40

(52) U.S. Cl. CPC G06Q 20/3278; G06Q 20/3274; G06Q 20/401

(57) ABSTRACT

A payment verification method includes: generating, by a payment collection device, verification information for a to-be-processed target payment transaction, and providing the verification information to a payment device; generating, by the payment device, payment information, and providing the payment information to the payment collection device, the payment information including payment account information and the verification information obtained from the payment collection device; after obtaining the payment information, performing, by the payment collection device, matching verification by using the verification information included in the payment information and the verification information locally generated; and if the matching verification succeeds, completing a payment request by using the account information included in the payment information.

### CROSS-REFERENCE TO RELATED APPLICATIONS

The present application is based upon and claims priority to Chinese Patent Application No. 202010767469.3, filed on Aug. 3, 2020, the entire content of which is incorporated herein by reference.

### TECHNICAL FIELD

The present specification relates to the field of information security technologies, and in particular, to a payment verification method and system.

### BACKGROUND

In an offline payment scenario, to improve payment efficiency, a user is allowed to perform payment by using an authentication-free method (also referred to as password-free payment) for some small amounts of payment, that is, the user does not need to perform any authentication (for example, a payment password, a fingerprint, and face authentication), and only needs to provide payment account information (for example, provide the payment account information in a form of a payment code) to perform payment.

Code scanning payment is used as an example. After completing shopping, the user can display the payment code to a payment collection device by using a payment device. After scanning the payment code, the payment collection device can establish a connection to a payment server to complete a payment process. In this method, the user does not need to perform an authentication operation, and only needs to perform an operation of displaying the payment code. Therefore, payment efficiency is improved.

However, because the user does not need to perform authentication, if an illegal user obtains payment account information, the illegal user can use the payment account information to perform payment, causing a property loss of the original user.

### SUMMARY

According to a first aspect of the present specification, a payment verification method includes: generating, by a payment collection device, verification information for a to-be-processed target payment transaction, and providing the verification information to a payment device; generating, by the payment device, payment information, and providing the payment information to the payment collection device, the payment information including payment account information and verification information obtained from the payment collection device; after obtaining the payment information, performing, by the payment collection device, matching verification by using the verification information included in the payment information and the verification information locally generated; and if the marching verification succeeds, completing a payment request by using account information included in the payment information.

According to a second aspect of the present specification, a payment verification system includes: a payment collection device and a payment device. The payment collection is configured to generate verification information for a to-be-processed target payment transaction, and provide the verification information to the payment device. The payment device is configured to generate payment information, and provide the payment information to the payment collection device, the payment information including payment account information and verification information obtained from the payment collection device. The payment collection device is further configured to: after obtaining the payment information, perform matching verification by using the verification information included in the payment information and the verification information locally generated; and if the verification succeeds, complete a payment request by using the account information included in the payment information.

According to a third aspect of the present specification, a payment collection device includes: a processor; and a memory storing instructions executable by the processor, wherein the processor is configured to: generate verification information for a to-be-processed target payment transaction, and provide the verification information to a payment device; obtain payment information sent by the payment device, wherein the payment information includes payment account information and the verification information; perform matching verification by using the verification information included in the payment information and the verification information locally generated; and if the matching verification succeeds, complete a payment request by using account information included in the payment information.

According to a fourth aspect of the present specification, a payment device includes: a processor; and a memory storing instructions executable by the processor, wherein the processor is configured to: obtain verification information sent by a payment collection device, wherein the verification information is generated by the payment collection device for a to-be-processed target payment transaction; generate payment information, the payment information including payment account information and the verification information obtained from the payment collection device; and provide the payment information to the payment collection device, for the payment collection device to perform matching verification by using the verification information included in the payment information and the verification information locally generated, and to complete a payment request by using account information included in the payment information if the matching verification succeeds.

In the embodiments of the present specification, because the payment collection device generates the verification information for the target payment transaction and provides the verification information to the payment device, and the payment device generates the payment information by using the verification information, the payment information provided by the payment device to the payment collection device is payment information only used for a current target payment transaction. As such, even if an illegal user obtains the payment information, the illegal user cannot use the payment information to pay for another transaction, and the original user still does not need to perform any authentication operation, thereby ensuring payment efficiency and improving payment security.

It should be understood that the general description above and the detailed description below are merely examples and illustrative, and do not limit the present specification.

### BRIEF DESCRIPTION OF DRAWINGS

The accompanying drawings, which are incorporated in and constitute a part of this specification, illustrate embodiments and, together with the description, serve to explain the principles of the specification.

FIG. 1 is a flowchart of a payment verification method according to an embodiment.

FIG. 2 is a flowchart of a verification information sending method according to an embodiment.

FIG. 3 is a flowchart of a verification information sending method according to an embodiment.

FIG. 4 is a schematic diagram of a payment verification apparatus according to an embodiment.

FIG. 5 is a schematic diagram of a payment verification apparatus according to an embodiment.

FIG. 6 is a schematic diagram illustrating a payment verification device according to an embodiment.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The described implementations are merely examples but not all of the implementations consistent with the present specification.

Terms used in the present specification are merely for illustrating examples, and are not intended to limit the present specification. For example, although the terms “first”, “second”, and “third” may be used in the present specification to describe various types of information, the information is not limited to the terms. These terms are merely used to differentiate between information of the same type. For example, without departing from the scope of the present specification, first information can also be referred to as second information, and similarly, second information can be referred to as first information. Depending on the context, for example, the word “if” used herein can be explained as “while”, “when”, or “in response to determining”.

With the development of Internet technologies, in a current offline payment scenario, a user can perform payment by using many Internet-based payment methods, for example, code scanning payment. Internet-based payment improves payment experience of the user. To further improve payment efficiency, the user is allowed to perform payment by using an authentication-free method (also referred to as password-free payment) for some small amounts of payment, that is, the user does not need to perform any authentication (for example, a payment password, a fingerprint, and face authentication), and only needs to provide payment account information (for example, provide the payment account information in a form of a payment code) to a payment collection device to perform payment.

Code scanning payment is used as an example. After completing shopping, the user can display the payment code to the payment collection device by using a terminal device. After scanning the payment code, the payment collection device can establish a connection to a payment server, and send a payment request to the payment server, to complete a current payment process. In this method, the user does not need to perform an authentication operation, and only needs to perform an operation of displaying the payment code. Therefore, payment efficiency is improved.

However, because the user can perform payment without authentication, if an illegal user obtains payment account information of the user, the illegal user can use the payment account information to perform payment, causing a property loss of the original user. Code scanning payment is still used as an example. If the payment code of the original user is obtained by the illegal user by using screen capturing software or photographing, the illegal user can use the payment code of the original user to perform payment. In addition, the payment code currently remains unchanged for a long time after the payment code is generated, that is, a specific period exists. If the payment code is obtained by the illegal user, the illegal user can use the payment code for payment a plurality of times within the period.

In view of the above, embodiments of the present specification provide a payment collection device that generates verification information for a to-be-processed target payment transaction, and provides the verification information to a payment device. The payment device generates payment information based on the verification information and payment account information, and provides payment information to the payment collection device. After obtaining the payment information, the payment collection device verifies the payment information by using the locally generated verification information. Only after the verification succeeds, the payment collection device completes a payment request by using the account information included in the payment information.

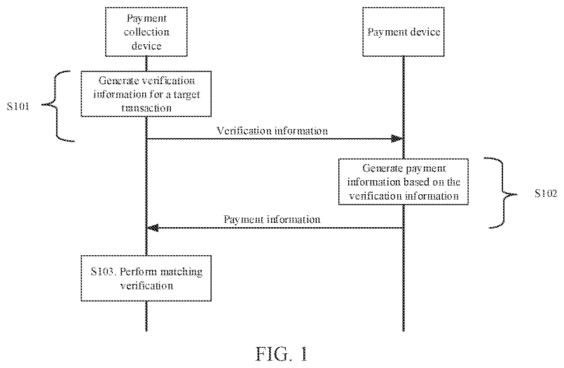

FIG. 1 is a flowchart of a payment verification method according to an embodiment. Referring to FIG. 1, the method may include the following steps.

In step S101, a payment collection device generates verification information for a to-be-processed target payment transaction, and provides the verification information to a payment device.

In an embodiment, when a payer user provides payment account information for payment, the payment collection device obtains information such as a specific payment amount first, waits to obtain the payment account information, establishes a connection to a payment server after obtaining the payment account information, and completes payment. After determining information such as a payment collection amount based on information entered by the user, the payment collection device can determine that a to-be-processed target payment transaction exists currently. For example, in a payment scenario, after a payee user or the payer user scans a to-be-paid commodity by using the payment collection device, the payment collection device determines that a to-be-processed payment transaction exists. In an embodiment, after a to-be-paid amount or a commodity is directly entered on the payment collection device, the payment collection device can determine that a to-be-processed payment transaction exists.

In an embodiment, when determining that the to-be-processed target payment transaction exists, the payment collection device can generate the verification information for the to-be-processed target payment transaction, and provide the verification information for the payment device. The generated verification information can be a plurality of types of information generated for the target payment transaction. For example, the verification information can be one or more of a current time, a payment amount of the target payment transaction, payee information of the target payment transaction, or a random number generated based on the current time. Any information that can be used to identify the current target payment transaction can be used as the verification information, which is not limited in the present specification.

For example, verification information generated based on a target payment transaction A can be a random number X generated based on a current time and a payment amount Y of the target payment transaction A. In this case, the payment collection device can locally record the information shown in Table 1.

TABLE 1

| Target payment | Verification |
|---|---|
| transaction | information |
| A | X and Y |

In step S102, the payment device generates payment information, and provides the payment information to the payment collection device, the payment information including payment account information and obtained verification information;

In an embodiment, after obtaining the verification information sent by the payment collection device, the payment device can generate the payment information based on the received verification information. The payment information can include one or more of the payment account information, the obtained verification information, or payment information of another user. After generating the payment information, the payment device can send the payment information to the payment collection device. With reference to the example in step S101, the payment information can include the verification information such as the random number X and the payment amount Y.

In an embodiment, the payment information can be a payment two-dimensional code, and the payment two-dimensional code can be obtained by encoding the account information and the verification information. In another embodiment, the payment information can exist in another form, which is not limited in the present specification.

For example, the payment information is a payment two-dimensional code. The payment device can display the payment two-dimensional code in an interactive interface in a form of a picture, so that the payment collection device obtains the payment two-dimensional code information through code scanning, namely, the payment information.

Also for example, the payment device can transmit the payment two-dimensional code information to the payment device by using a wireless signal, for example, transmit the payment two-dimensional code information to the payment device by using a Near Field Communication (NFC) technology, so that the payment device can obtain the payment two-dimensional code information, that is, obtain the payment information.

In an embodiment, the payment device can transmit the payment information in another form to the payment collection device by using a wireless signal. For example, the generated payment information in another form does not need to be encoded into the payment two-dimensional code information but is directly sent to the payment collection device, which is not limited in the present specification. Compared with the method of displaying the picture of the payment two-dimensional code, a wireless signal transmission method is more convenient for the user to operate, that is, the user does not need to display the picture of the payment code, and can complete a payment process by simply moving the payment device close to the payment collection device, thereby improving user experience.

In step S103, after obtaining the payment information, the payment collection device performs matching verification by using the verification information included in the payment information and the locally generated verification information, and if the verification succeeds, completes a payment request by using the account information included in the payment information.

In an embodiment, after obtaining the payment information sent by the payment device, the payment collection device can parse the payment information to obtain the verification information and the payment account information. For example, with reference to the example in step S102, the payment information is the payment two-dimensional code information. After obtaining the payment two-dimensional code information, the payment collection device can parse the payment two-dimensional code information to obtain the verification information and the payment account information in the payment two-dimensional code information.

After obtaining the verification information, the payment collection device can search for the generated verification information locally, and perform matching verification by using the verification information included in the payment information and the locally generated verification information. With reference to the examples in steps S101 and S102, the payment collection device can determine whether the verification information included in the payment information is the random number X and the payment amount Y that correspond to the target transaction A. If the verification information included in the payment information is the random number X and the payment amount Y that correspond to the target transaction A, the payment collection device determines that the matching verification succeeds.

If the matching verification succeeds, it indicates that the payment information is used to pay for the current target payment transaction. Therefore, the payment request can be completed by using the account information included in the payment information, that is, a connection can be established to the payment server. After the connection is established, the account information included in the payment information can be sent to the payment server to complete the current payment request.

If the matching verification fails, it indicates that the payment information does not include the verification information used to pay for the current target payment transaction. Therefore, the payment collection device can directly determine that the payment information is invalid, and does not obtain the payment account information in the payment information to further complete the payment request.

In the embodiments of the present specification, because the payment collection device generates the verification information for the target payment transaction and provides the verification information to the payment device, and the payment device generates the payment information by using the verification information, the payment information provided by the payment device to the payment collection device is payment information only used for a current target payment transaction. As such, even if an illegal user obtains the payment information, the illegal user cannot use the payment information to pay for another transaction, and the original user still does not need to perform authentication operation, thereby ensuring payment efficiency and improving payment security.

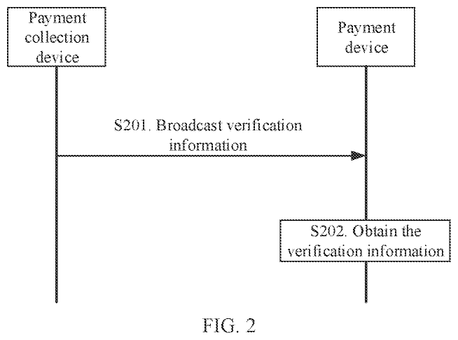

FIG. 2 is a flowchart of a verification information sending method according to an embodiment. For example, the method may be used to implement step S101 (FIG. 1). As shown in FIG. 2, the method may include the following steps.

In step S201, the payment collection device generates and broadcasts a first wireless signal that includes the verification information.

With reference to step S101 (FIG. 1), after determining that the to-be-processed target payment transaction exists, and generating the corresponding verification information, the payment collection device can directly generate the first wireless signal that includes the verification information, and broadcast the first wireless signal. The wireless signal can use a plurality of forms, such as NFC and Bluetooth.

In step S202, the payment device obtains the verification information from the first wireless signal after detecting the first wireless signal.

In an offline payment scenario, because the payment device is relatively close to the payment collection device, the payment device can detect the first wireless signal, and can obtain the verification information from the first wireless signal after detecting the first wireless signal.

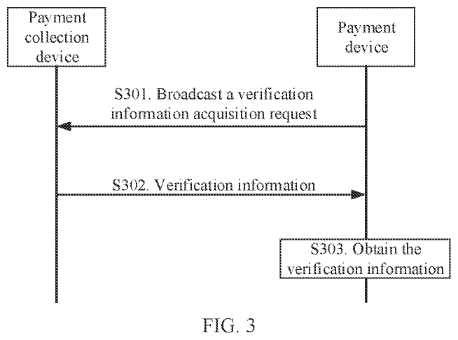

FIG. 3 is a flowchart of a verification information sending method according to an embodiment. For example, the method may be used to implement step S101 (FIG. 1). As shown in FIG. 3, the method may include the following steps.

In step S301, the payment device generates and broadcasts a second wireless signal that includes a verification information acquisition request.

For example, the payment device can generate the verification information acquisition request, and add the verification information acquisition request into the second wireless signal for broadcast.

In an embodiment, when determining that a payment requirement exists, the payment device can generate and broadcast the second wireless signal that includes the verification information acquisition request. For example, when detecting a triggering operation of the user, the payment device determines that the payment requirement exists. In a code scanning payment scenario, the payment device can determine that the payment requirement exists when detecting an operation of displaying a payment code by the user.

In an embodiment, when detecting that the payment device is surrounded by the payment collection device, the payment device can generate and broadcast the second wireless signal that includes the verification information acquisition request. For example, after detecting an NFC or Bluetooth signal of the payment collection device, the payment device determines that the payment device is surrounded by the payment collection device.

In step S302, after detecting the second wireless signal, the payment collection device sends a third wireless signal that includes the verification information to the payment device.

For example, after detecting the second wireless signal broadcast by the payment device, the payment collection device can add the payment information corresponding to the target payment transaction into the third wireless signal to send the payment information to the payment device.

In an embodiment, to save processing resources of the payment collection device, the payment collection device can generate the verification information for the current to-be-processed target payment transaction after detecting the second wireless signal sent by the payment device.

In another embodiment, the payment collection device can generate the verification information immediately after determining that the to-be-processed target payment transaction exists, which is not limited in the present specification.

In step S303, the payment device obtains the verification information from the third wireless signal.

For example, after receiving the third wireless signal, the payment device can obtain the verification information from the third wireless signal.

The above two methods in FIG. 2 and FIG. 3 do not require additional operations by the payer user or the payee user, that is, the payment collection device and the payment device can exchange information without being precepted by the user, thereby ensuring payment efficiency and improving payment security.

In the above embodiments, the payment collection device performs: generating verification information for a to-be-processed target payment transaction, and providing the verification information to a payment device; after obtaining payment information sent by the payment device, performing matching verification by using verification information included in the payment information and the locally generated verification information; and if the verification succeeds, completing a payment request by using account information included in the payment information.

In the above embodiments, the payment device performs: obtaining verification information sent by a payment collection device; and generating payment information, and providing the payment information to the payment collection device, so that the payment collection device performs matching verification by using verification information included in the payment information and locally generated verification information, and completes a payment request by using account information included in the payment information.

For example, after a user completes shopping in a supermarket and arrives at a checkout, a cashier uses a payment collection device to scan each commodity purchased by the user. After completing scanning, the payment collection device determines that a to-be-processed target payment transaction exists currently. Therefore, the payment collection device generates corresponding verification information based on the target payment transaction. The verification information may include a current time, a transaction amount, and collection account information. After the verification information is generated, the verification information is broadcast by using a Bluetooth wireless signal. After detecting the wireless signal, a mobile terminal of the user, i.e., the payment device, obtains the verification information from the wireless signal, and generates a payment two-dimensional code that includes the verification information and payment account information. After the user taps to display the payment two-dimensional code, the mobile terminal of the user displays a picture of the payment two-dimensional code. After scanning the picture of the payment two-dimensional code, the payment collection device establishes a connection to a payment server to complete a payment process.

In the example, because the generated payment two-dimensional code can be only used to pay for the current target payment transaction, even if an illegal user obtains the payment two-dimensional code through photographing or capturing, the payment two-dimensional code cannot be used to pay for another transaction. Therefore, payment security in a password-free payment scenario is improved.

Corresponding to the above payment verification method, the present specification further provides a payment verification system including a payment collection device and a payment device.

The payment collection device is configured to generate verification information for a to-be-processed target payment transaction, and provide the verification information to the payment device.

The payment device is configured to generate payment information, and provide the payment information to the payment collection device, the payment information including payment account information and obtained verification information.

The payment collection device is configured to: after obtaining the payment information, perform matching verification by using the verification information included in the payment information and the locally generated verification information; and if the verification succeeds, complete a payment request by using the account information included in the payment information.

In an embodiment, the payment collection device is configured to generate and broadcast a first wireless signal that includes the verification information; and the payment device is configured to obtain the verification information from the first wireless signal after detecting the first wireless signal.

In an embodiment, the payment device is configured to generate and broadcast a second wireless signal that includes a verification information acquisition request; the payment collection device is configured to: after detecting the second wireless signal, send a third wireless signal that includes the verification information to the payment device; and the payment device is configured to obtain the verification information from the third wireless signal.

In an embodiment, the payment information is a payment two-dimensional code, and the payment two-dimensional code is obtained by encoding the account information and the verification information.

In an embodiment, the payment collection device is configured to obtain the payment information through code scanning.

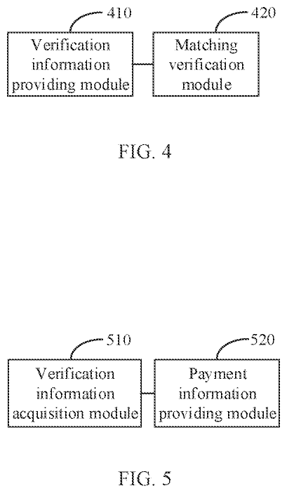

FIG. 4 is a schematic diagram of a payment verification apparatus according to an embodiment. Corresponding to the payment verification method, the payment verification apparatus includes: a verification information providing module 410 configured to generate verification information for a to-be-processed target payment transaction, and provide the verification information to a payment device; and a matching verification module 420 configured to: after obtaining payment information sent by the payment device, perform matching verification by using verification information included in the payment information and the locally generated verification information; and if the verification succeeds, complete a payment request by using account information included in the payment information.

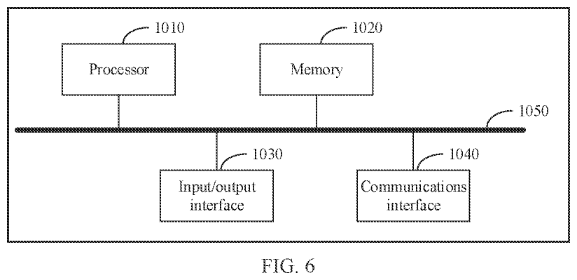

FIG. 5 FIG. 4 is a schematic diagram of a payment verification apparatus according to an embodiment. Corresponding to the above payment verification method, the payment verification apparatus includes: a verification information acquisition module 510 configured to obtain verification information sent by a payment collection device; and a payment information providing module 520 configured to generate payment information, and provide the payment information to the payment collection device, so that the payment collection device performs matching verification by using verification information included in the payment information and locally generated verification information, and completes a payment request by using account information included in the payment information.

For an implementation process of functions and roles of each component in the above apparatuses, reference can be made to a corresponding step in the above method. The above described apparatus implementations are merely examples. Some or all of the modules can be selected based on actual needs.

Embodiments of the present specification further provide a payment verification device. The payment verification device includes a processor, and a memory storing instructions executable by the processor. The processor implements the above method when executing the instructions.

For example, the payment verification device may be the above payment collection device. Accordingly, the processor is configured to perform: generating verification information for a to-be-processed target payment transaction, and providing the verification information to a payment device; after obtaining payment information sent by the payment device, performing matching verification by using the verification information included in the payment information and the locally generated verification information; and if the verification succeeds, completing a payment request by using account information included in the payment information.

For example, the payment verification device may be the above the payment device. Accordingly, the processor is configured to perform: obtaining verification information sent by a payment collection device; and generating payment information, and providing the payment information to the payment collection device, so that the payment collection device performs matching verification by using verification information included in the payment information and locally generated verification information, and completes a payment request by using account information included in the payment information.

FIG. 6 is a schematic diagram of a payment verification device according to an embodiment. The device can include a processor 1010, a memory 1020, an input/output interface 1030, a communications interface 1040, and a bus 1050. The processor 1010, the memory 1020, the input/output interface 1030, and the communications interface 1040 are communicatively connected to each other inside the device by using the bus 1050.

The processor 1010 can be implemented by using a general central processing unit (CPU), a microprocessor, an application-specific integrated circuit (ASIC), one or more integrated circuits, etc., and is configured to execute instructions to perform the above method.

The memory 1020 can be implemented by using a read-only memory (ROM), a random access memory (RAM), a static storage device, a dynamic storage device, etc. The memory 1020 can store an operating system, and instructions executable by the processor 1010 to perform the above method.

The input/output interface 1030 is configured to be connected to an input/output module, to input or output information. The input/output module (not shown) can be used as a component and configured in the device, or can be externally connected to the device to provide a corresponding function. The input device can include a keyboard, a mouse, a touchscreen, a microphone, various sensors, etc. The output device can include a monitor, a speaker, a vibrator, an indicator, etc.

The communications interface 1040 is configured to be connected to a communications module (not shown), to implement a communication interaction between the device and another device. The communications module can perform communication in a wired method (for example, USB or a network cable), or can perform communication in a wireless method (for example, a mobile network, Wi-Fi, NFC, or Bluetooth).

The bus 1050 is configured to transmit information between components (for example, the processor 1010, the memory 1020, the input/output interface 1030, and the communications interface 1040) of the device.

It should be noted that although only the processor 1010, the memory 1020, the input/output interface 1030, the communications interface 1040, and the bus 1050 of the device are shown, the device can further include other components needed for implementing normal running. In addition, a person skilled in the art can understand that the device does not necessarily include all components shown in the figure.

Embodiments of the present specification further provide a non-transitory computer readable storage medium. The computer readable storage medium stores computer instructions for performing the above payment verification method.

For example, the method performed by the payment collection device includes: generating verification information for a to-be-processed target payment transaction, and providing the verification information to a payment device; after obtaining payment information sent by the payment device, performing matching verification by using the verification information included in the payment information and the locally generated verification information; and if the verification succeeds, completing a payment request by using account information included in the payment information.

For example, the method performed by the payment device includes: obtaining verification information sent by a payment collection device; and generating payment information, and providing the payment information to the payment collection device, so that the payment collection device performs matching verification by using verification information included in the payment information and locally generated verification information, and completes a payment request by using account information included in the payment information.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer readable medium does not include transitory media such as a modulated data signal and carrier.

The system, apparatus, module, or device described above can be implemented by using a computer chip or an entity, or can be implemented by using a product having a certain function. An example implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The apparatuses described above are merely examples. The modules described as separate parts may or may not be physically separate. Each module may be implemented as software, or hardware, or a combination of software and hardware. Some or all of the modules can be selected based on an actual need.

The foregoing description is merely example embodiments of the present specification, and is not used to limit the present specification. For those skilled in the art, the present specification can have various alterations and changes. Any modifications, equivalent replacements, improvements, etc. made within the spirit and principle of the present specification shall be included in the scope of the claims.

1. A payment verification method, comprising:
generating, by a payment collection device, verification information for a to-be-processed target payment transaction, and providing the verification information to a payment device;
generating, by the payment device, payment information, and providing the payment information to the payment collection device, the payment information including payment account information and the verification information obtained from the payment collection device;
after obtaining the payment information, performing, by the payment collection device, matching verification by using the verification information included in the payment information and the verification information locally generated; and
if the matching verification succeeds, completing a payment request by using the account information included in the payment information.

2. The method according to claim 1, wherein the providing, by the payment collection device, the verification information to the payment device comprises:
generating and broadcasting, by the payment collection device, a first wireless signal that includes the verification information; and
obtaining, by the payment device, the verification information from the first wireless signal after detecting the first wireless signal.

3. The method according to claim 1, wherein the providing, by the payment collection device, the verification information to the payment device comprises:
generating and broadcasting, by the payment device, a second wireless signal that includes a verification information acquisition request;
after detecting the second wireless signal, sending, by the payment collection device, a third wireless signal that includes the verification information to the payment device; and
obtaining, by the payment device, the verification information from the third wireless signal.

4. The method according to claim 1, wherein:
the payment information is a payment two-dimensional code, and the payment two-dimensional code is obtained by encoding the account information and the verification information.

5. The method according to claim 4, wherein the obtaining, by the payment collection device, the payment information includes:
obtaining, by the payment collection device, the payment information through code scanning.

6. A payment verification system, comprising:
a payment collection device; and
a payment device,
wherein the payment collection device and the payment device are configured to perform the method according to claim 1.

7. A payment collection device, comprising:
a processor; and
a memory storing instructions executable by the processor,
wherein the processor is configured to:
generate verification information for a to-be-processed target payment transaction, and provide the verification information to a payment device;
obtain payment information sent by the payment device, wherein the payment information includes payment account information and the verification information;
perform matching verification by using the verification information included in the payment information and the verification information locally generated; and
if the matching verification succeeds, complete a payment request by using account information included in the payment information.

8. The payment collection device according to claim 7, wherein the processor is further configured to generate and broadcast a first wireless signal that includes the verification information, for the payment device to obtain the verification information from the first wireless signal after detecting the first wireless signal.

9. The payment collection device according to claim 7, wherein the payment device generates and broadcasts a second wireless signal that includes a verification information acquisition request, and the processor is further configured to:
after detecting the second wireless signal, send a third wireless signal that includes the verification information to the payment device; for the payment device to obtain the verification information from the third wireless signal.

10. The payment collection device according to claim 7, wherein:
the payment information is a payment two-dimensional code, and the payment two-dimensional code is obtained by encoding the account information and the verification information.

11. The payment collection device according to claim 10, wherein the processor is further configured to obtain the payment information through code scanning.

12. A payment device, comprising:
a processor; and
a memory storing instructions executable by the processor,
wherein the processor is configured to:
obtain verification information sent by a payment collection device, wherein the verification information is generated by the payment collection device for a to-be-processed target payment transaction;
generate payment information, the payment information including payment account information and the verification information obtained from the payment collection device; and
provide the payment information to the payment collection device, for the payment collection device to perform matching verification by using the verification information included in the payment information and the verification information locally generated, and to complete a payment request by using account information included in the payment information if the matching verification succeeds.

13. The payment device according to claim 12, wherein the processor is further configured to:
obtain the verification information from a first wireless signal broadcasted by the payment collection device after detecting the first wireless signal.

14. The payment device according to claim 12, wherein the processor is further configured to:
generate and broadcast a second wireless signal that includes a verification information acquisition request; and
obtain the verification information from a third wireless signal, the third wireless signal being sent by the payment collection device after detecting the second wireless signal, and including the verification information.

15. The payment device according to claim 12, wherein:
the payment information is a payment two-dimensional code, and the payment two-dimensional code is obtained by encoding the account information and the verification information.
